(19) United States
(12) Patent Application Publication
(10) Pub. No.: US 2008/0035000 A1
(43) Pub. Date: Feb. 14, 2008

(54) Matte Agent for Infrared-Sensitive Planographic Printing Plate and Use Thereof

(76) Inventors: Yasushi Miyamoto, Tatebayashi (JP); Hirokazu Fujii, Saitama-ken (JP); Akira Igarashi, Saitama-ken (JP); Yasuhiko Kojima, Saitama-ken (JP)

Correspondence Address: EASTMAN KODAK COMPANY;PATENT LEGAL STAFF, 343 STATE STREET, ROCHESTER, NY, 14650-2201, US

(21) Appl. No.: 11/575,879

(22) PCT Filed: Oct. 6, 2005
(86) PCT No.: PCT/JP05/18824

§ 371 Date: Mar. 23, 2007

(30) Foreign Application Priority Data
Oct. 8, 2004 (JP) 2004-296859
Oct. 6, 2005 (JP) 2005/018824

(51) Int. Cl. B41C 1/10; G03C 1/32

(52) U.S. Cl. 101/457; 252/587

(57) ABSTRACT

The present invention provides a photosensitive lithographic printing plate which is excellent in both workability and image forming properties and is also capable of omitting the use of a laminated-paper. The present invention also provides an interleaving sensitive granular matting agent for photosensitive lithographic printing plate, which is used by applying onto the surface of an infrared-sensitive lithographic printing plate, comprising an infrared absorbing dye. Surface treatment is conducted by applying a granular matting agent containing an infrared absorbing dye onto the surface of an infrared-sensitive lithographic printing plate.

### TECHNICAL FIELD

The present invention relates to an infrared-sensitive lithographic printing plate and, more particularly, to a granular matting agent for an infrared-sensitive lithographic printing plate used in a CTP system.

### BACKGROUND ART

With the progress of computer image processing techniques, a method of directly writing images on a photosensitive layer by light irradiation, in response to digital signals, has recently been developed and thus an intense interest has been shown toward a computer-to-plate (CTP) system in which images are directly formed on a photosensitive lithographic printing plate, without outputting the images to a silver salt mask film, by employing the method on a lithographic printing plate precursor. The CTP system, which uses high-output laser having a maximum intensity within a near infrared or infrared range as a light source for light irradiation, has the following advantages: images having high resolution can be obtained by exposure within a short time and the photosensitive lithographic printing plate used in the system can be handled in a lighted room. Regarding solid and semiconductor lasers capable of emitting infrared ray having a wavelength of 760 to 1200 nm, a high-output and portable laser is readily available.

As a positive working photosensitive lithographic printing plate material for a CTP system, for example, a printing plate material obtained by adding a photothermal conversion material and a quinonediazide compound to an alkali soluble resin is known. In the image area of the positive working lithographic printing plate, the quinonediazide compound functions as a dissolution inhibitor which substantially decreases alkali solubility of the alkali soluble resin. In the non-image area, the quinonediazide compound is decomposed by heat to lose the dissolution inhibiting capability and, thus, the alkali soluble resin is removed by an alkali developing solution to form images.

As a negative working photosensitive lithographic printing plate for CTP system, there is known a printing plate in which, by introducing a substance which generates an acid due to light or heat into a photosensitive layer, the condensation crosslinking reaction is caused by a heat treatment after exposure using the acid generated on exposure as a catalyst, and the photosensitive layer of the exposed area is cured to form images. There is also known a printing plate in which, by introducing a substance which generates a radical due to light or heat into a photosensitive layer, the polymerization reaction is caused using the radical generated on exposure as an initiator, and the photosensitive layer of the exposed area is cured to form images.

By the way, the surface of a photosensitive layer is usually coated with a paper referred to as a interleaving paper so as to protect the surface of the photosensitive layer of a photosensitive lithographic printing plate, and then the photosensitive lithographic printing plate is stored and conveyed.

However, in the above-described photosensitive lithographic printing plate for CTP system, the photosensitive layer has a soft surface and the surface is likely to be softened with moisture. Therefore, when the number of photosensitive lithographic printing plates to be laminated increases, a blocking phenomenon arises between the surface of the photosensitive layer and the interleaving paper and, thus, it can be difficult to peel the interleaving paper.

Some CTP systems are provided with such a system that, in case of automatically supplying a photosensitive lithographic printing plate to an exposure apparatus, a interleaving paper is removed from the surface of a photosensitive layer using a rubber roller or is peeled from the surface of the photosensitive layer by sucking the interleaving paper using a sucker. When the blocking phenomenon arises between the surface of the photosensitive layer and the interleaving paper, a portion of the interleaving paper adheres to the surface of the photosensitive layer and also a portion of the surface of the photosensitive layer may be damaged.

Japanese Unexamined Patent Publication No. 2000-235255 describes that a matting agent is applied onto the surface of a photosensitive lithographic printing plate to form irregularity on the surface of the photosensitive layer. Consequently, a contact area between the surface of the photosensitive layer and the interleaving paper decreases and, thus, excessive adhesion can be avoided and workability is improved. Also it is possible to store and convey photosensitive lithographic printing plates while being directly contacted with each other. Consequently, the use of the interleaving paper can be omitted

However, according to the kind of the matting agent to be used, the photosensitive layer is not quickly removed during the development in the non-image area of the photosensitive lithographic printing plate, and therefore remains on the surface of a support, resulting in contamination of the non-image area due to adhesion of ink. Alternatively, voids or missing parts appear in the image area. Therefore, it has been required to develop a photosensitive lithographic printing plate which is excellent in both workability and image forming properties.

### DISCLOSURE OF THE INVENTION

An object of the present invention is to provide a photosensitive lithographic printing plate which is excellent in both workability and image forming properties and also does not require the use of a laminated-paper.

The object of the present invention is achieved by a granular matting agent for photosensitive lithographic printing plate, which is used by applying onto the surface of an infrared-sensitive lithographic printing plate, wherein the matting agent comprises an infrared absorbing dye.

Also the present invention relates to a method for a surface treatment of a photosensitive lithographic printing plate, wherein the method comprises applying a granular matting agent containing an infrared absorbing dye onto the surface of an infrared-sensitive lithographic printing plate, and an infrared-sensitive lithographic printing plate comprising a granular matting agent containing an infrared absorbing dye applied onto the surface.

The matting agent of the present invention may contain an alkali-soluble resin or a water-dispersible resin.

The present invention can provide a photosensitive lithographic printing plate which is excellent in both workability on removal of the interleaving paper and pickup of the photosensitive lithographic printing plate and image forming properties and, if necessary, does not need the interleaving paper.

### BRIEF DESCRIPTION OF THE DRAWINGS

FIG. 1 is a schematic view showing a method for evaluating suction/falling characteristics of the photosensitive lithographic printing plates in examples.

### BEST MODE FOR CARRYING OUT THE INVENTION

The present invention is mainly characterized by the use of a matting agent containing an infrared absorbing dye. The present invention will now be described in detail below.

<Matting Agent>

The matting agent used in the present invention contains an infrared absorbing dye. Specific examples of the infrared absorbing dye include, but are not limited to, various dyes and, for example, can be materials having a maximum absorption wavelength within a near infrared or infrared range, for example, a maximum absorption wavelength within a range from 760 nm to 1200 nm.

The dyes used in the present invention are conventionally known commercially available dyes described, for example, in “Dye Handbook” (edited by the Association of Organic Synthesis Chemistry, published 1970), “Handbook of Color Material Engineering” (edited by the Japan Society of Color Material, Asakura Shoten K. K., published 1989), “Technologies and Markets of Industrial Pigments” (CMC, published 1983), and “Chemical Handbook, Applied Chemistry Edition” (edited by The Chemical Society of Japan, Maruzen Shoten K. K., published 1986). Specific examples of the dyes include azo dyes, azo dyes in the form of metal complex salts, pyrazolone azo dyes, anthraquinone dyes, phthalocyanine dyes, carbonium dyes, quinonimine dyes, methine dyes, cyanine dyes, indigo dyes, quinoline dyes, nitro-based dyes, xanthene dyes, thiazine-based dyes, azine dyes, and oxazine dyes.

Examples of the dye capable of efficiently absorbing near infrared radiation or infrared radiation include cyanine dyes, methine dyes, naphthoquinone dyes, squalirium dyes, arylbenzo(thio)pyridinium salts, trimethinethiapyrylium salts, pyrylium-based compounds, pentamethinethiopyrylium salts and infrared absorbing dyes.

Among these dyes, near infrared absorbing cationic dyes represented by the following general formula (1):
D⁺A⁻ (1)
wherein D⁺ represents a cationic dye having an absorption in a near infrared range and A⁻ represents an anion, are preferable.

Examples of the cationic dye D⁺ having an absorption in a near infrared range include cyanine-based dyes, triarylmethane-based dyes, ammonium-based dyes and diimmonium-based dyes, each having an absorption in a near infrared range. Specific examples of the cationic dye having an absorption in a near infrared range include dyes represented by the following formula (2):

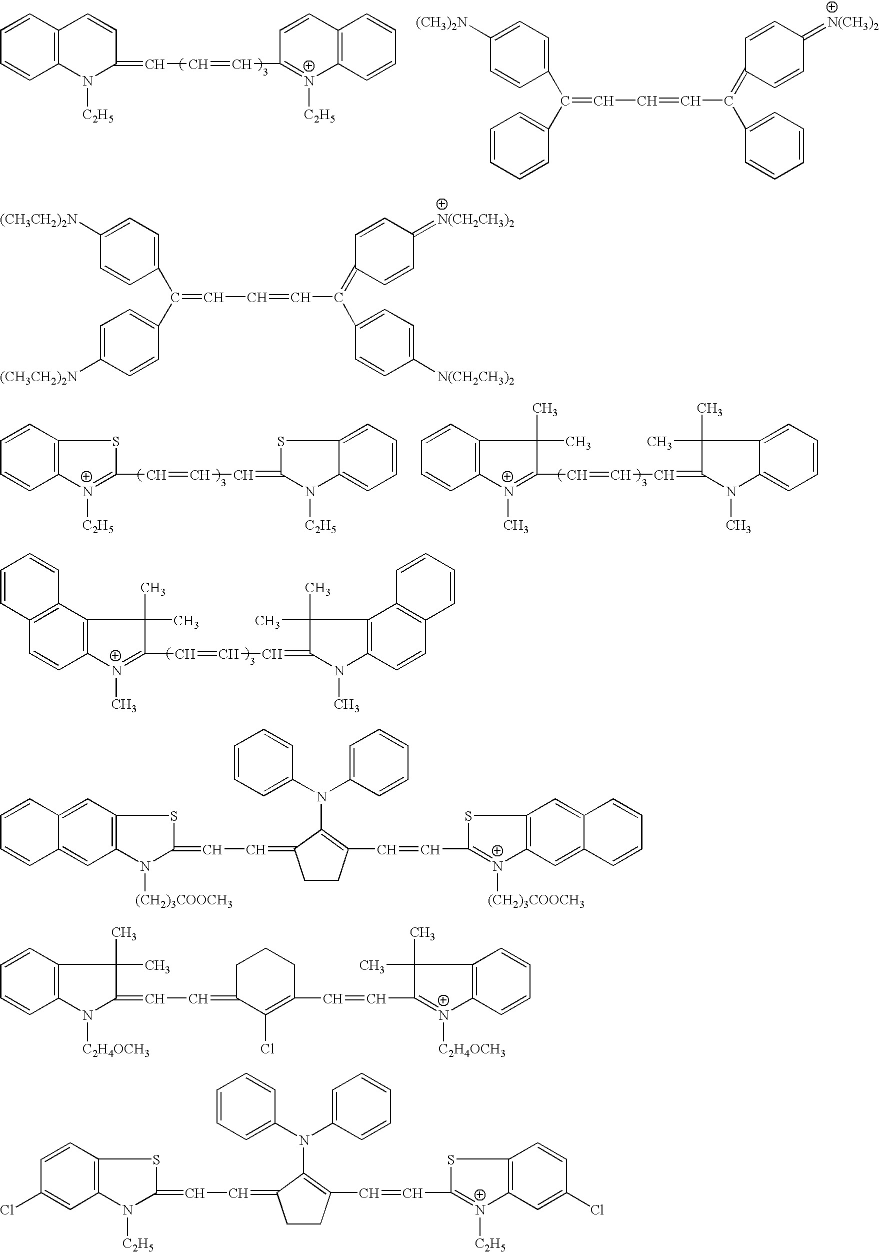

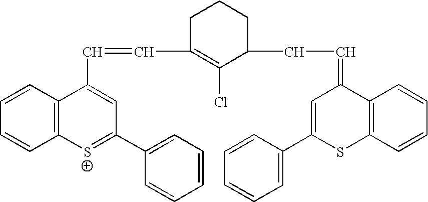

Examples of the anions include halogen anions, ClO₄⁻, PF₆⁻, BF₄⁻, SbF₆⁻, CH₃SO₃⁻, CF₃SO₃⁻, C₆H₅SO₃⁻, CH₃C₆H₄SO₃⁻, HOC₆H₄SO₃⁻, ClC₆H₄SO₃⁻, and boron anions represented by the following formula (3): 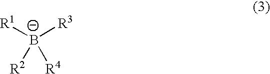
wherein R¹, R², R³ and R⁴ each independently represents an alkyl group, an aryl group, an alkaryl group, an allyl group, an aralkyl group, an alkenyl group, an alkynyl group, an alicyclic group, or a saturated or unsaturated heterocyclic group, and at least one of R¹, R², R³ and R⁴ is an alkyl group having 1 to 8 carbon atoms. The boron anion is preferably a triphenyl n-butylboron anion or a trinaphthyl n-butylboron anion.

Particularly preferred infrared absorbing dyes are as follows:

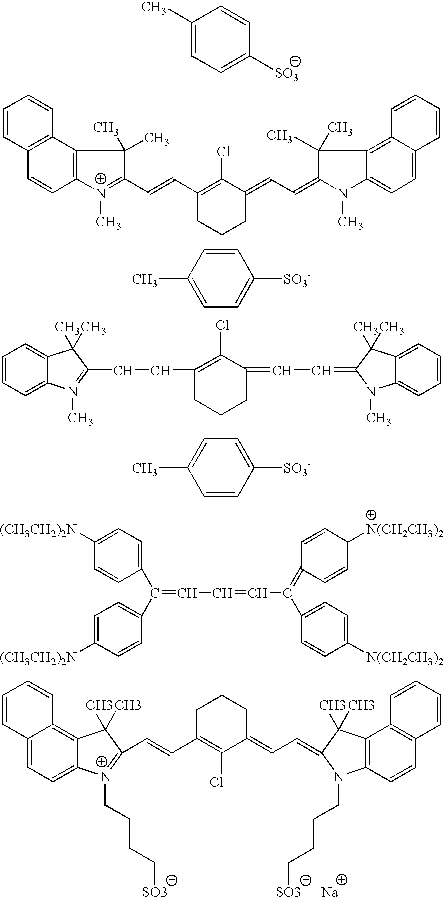

The content of the dye is preferably within a range from 0.001 to 30% by mass, and particularly preferably from 0.01 to 10% by mass, based on the matting agent. When the content of the dye is less than 0.001%, the resulting matting agent is insufficient in absorption of infrared radiation. On the other hand, when the content of the dye is more than 30% by mass, absorption of infrared radiation is substantially saturated and the effect of the addition of the dye may not increase, and therefore it is not preferred.

The matting agent of the present invention is granulate (fine powders or fine particles) and is composed of an infrared absorbing dye and other components. Examples of constituent components other than the infrared absorbing dye of the matting agent include, but are not limited to, polyvinyl acetate, polyvinylidene chloride, polyethylene oxide, polyethylene glycol, polyacrylic acid, polyacrylamide, polyacrylic acid alkyl ester, polystyrene and polystyrene derivative and copolymer using monomer constituting these polymers, polyvinyl methyl ether, epoxy resin, phenol resin, polyamide, polyvinyl butyral, silicon dioxide, diatomaceous earth, zinc oxide, titanium oxide, zirconium oxide, glass, alumina, dextrine, starch, calcium stearate, zinc stearate and polysaccharide fatty acid ester.

The matting agent is preferably soluble in an alkali developing solution or is dispersible in water. As the constituent component of a developing solution-soluble matting agent, various alkali-soluble resins or water-dispersible resins can be preferably used.

As the alkali-soluble resin, hydroxyethyl cellulose, hydroxypropyl cellulose, carboxymethyl cellulose, polyvinyl pyrrolidone, polyvinyl alcohol, polyacrylic acid, polyacrylic acid alkyl ester, polystyrene derivatives and phenol resin are preferable, and alkali-soluble resins such as phenol-formaldehyde resin, cresol-formaldehyde resin and phenol-cresol-formaldehyde co-condensed resin are particularly preferable.

As the water-dispersible resin, a copolymer derived from (meth)acrylic acid, alkyl(meth)acrylate, acid anhydride, acrylamide, acrylonitrile or styrene as one of essential monomers is preferably employed. Particularly, hydrophilized styrene copolymer, (meth)acrylic acid ester copolymer, vinyl ester copolymer, vinyl ether copolymer and vinyl ketone copolymer, each having an anionic group such as carboxylic acid anion, sulfonic acid anion, sulfuric acid anion, phosphonic acid anion or phosphoric acid anion group, and a copolymer having a sulfonamide group (—SO₂NHR, wherein R represents a hydrogen atom or an alkyl group) and/or an active imino group (—SO₂NH— or —CONXCO—, wherein X represents a hydrogen atom, a hydroxyl group or a sulfamoyl group) are preferable.

The matting agent may have a spherical, spindle, plate or any other shape, and the surface of the matting agent may be modified for the purpose of preventing the matting agents from aggregating with each other. An average particle size of the matting agent is preferably from 0.01 to 200 μm, more preferably from 0.1 to 150 μm, and still more preferably from 1 to 100 μm.

To the matting agent, various additives for enhancing sensitivity, such as cyclic anhydrides, colorants (dyes, pigments), surfactants, defoamers and acid generator can be added, if necessary.

Examples of the cyclic anhydride include succinic anhydride, glutaric anhydride, itaconic anhydride, phthalic anhydride, tetrahydrophthalic anhydride, hexahydrophthalic anhydride, maleic anhydride, chloromaleic anhydride and pyromellitic anhydride. These cyclic anhydrides can account for 1 to 15% by mass of the matting agent.

Examples of the colorant include basic oil-soluble dyes such as Crystal Violet, Malachite green, Victoria Blue, Methylene Blue, Ethyl Violet and Rhodamine B. Examples of the commercially available colorant include dyes such as “Victoria Pure Blue BOH” [manufactured by HODOGAYA CHEMICAL Co., Ltd.], “Oil Blue #603” [manufactured by Orient Chemical Industries, LTD.], “VPB-Naps (naphthalenesulfonate of Victoria Pure Blue)” [manufactured by HODOGAYA CHEMICAL Co., Ltd.] and “D11” [manufactured by PCAS Co.]; and pigments such as Phthalocyanine Blue, Phthalocyanine Green, Dioxadine Violet, Quinacridone Red and Metanyl Yellow.

Examples of the surfactant include fluorine-based surfactants such as FC430 (manufactured by 3M Co.) and silicone-based surfactants such as DC190 (manufactured by Dow Corning Co.).

Examples of the defoamer include an aqueous emulsion of a silicone compound, such as Defoamer T (manufactured by Nikko Chemicals Co., Ltd.) and other surfactants.

Examples of the acid generator include onium salts, especially iodonium, sulfonium, phosphonium, selenonium, diazonium and arsonium salts. Specific examples of particularly useful onium salt include diphenyliodonium hexafluorophosphate, diphenyliodonium tetrafluoroborate, triphenylsulfonium hexafluoroborate, triphenylsulfonium tetrafluoroborate, phenylmethyl-o-cyanobenzylsulfonium trifluoromethanesulfonate, 2-methoxy-(4-phenylamino)-phenyldiazonium hexafluorophosphate and 3-diazo-4-methoxydiphenylamine trifluoromethanesulfonate.

The matting agent can be obtained by dissolving or dispersing uniformly the above respective components in an alcohol-based solvent such as 1-methoxy-2-propanol, methanol or isopropyl alcohol, a ketone-based solvent such as methyl ethyl ketone, an ether-based solvent such as ethylene glycol monomethyl ether (methyl cellosolve), and other organic solvents, and water, organic solvents, or a mixture of an organic solvent and water, followed by drying. If necessary, the dried product may be ground, classified or granuled. However, it is preferred to directly obtain a granulate by spray drying in view of producibility.

The method of applying a matting agent onto the surface of a photosensitive lithographic printing plate is not specifically limited and examples thereof include, for example, a method of spraying a powdered matting agent onto the surface; a method of directly applying a dispersion of a matting agent, followed by drying; and a method of spraying a dispersion or solution of a matting agent, followed by drying.

When the powdered matting agent is sprayed onto the surface of the photosensitive lithographic printing plate, it is preferred to uniformly disperse or spray the matting agent onto a photosensitive layer using methods such as powder coating method, fluidizing coating method, electrostatic powder spraying method and electrostatic fluidizing coating method. After spraying, the matting agent can be fused on the surface of the photosensitive layer by appropriately subjecting to a heat treatment (fusing treatment). The fusing treatment can be carried out by putting in an oven heated to a temperature within a range from 50 to 130° C. using a heat source such as hot air or infrared heater, or melting the matting agent through a heated roll. At this time, as a portion of the matting agent is fused while being integrated and the melt is fixed on the photosensitive layer in the form of a spherical cap, the effect of preventing blocking can be exerted.

When the dispersion of the matting agent is to be directly applied on the photosensitive lithographic printing plate and then fused upon drying, this can be achieved by applying a dispersion obtained by dispersing the matting agent in an organic solvent, which does not dissolve the photosensitive layer of the photosensitive lithographic printing plate, water, or a mixture thereof, using ultrasonic waves, followed by drying. Also a uniform dispersion of constituent components of the matting agent used in the production of the matting agent may be directly applied on the photosensitive layer, and then dried.

When the dispersion or solution of the matting agent is sprayed onto the surface of the photosensitive lithographic printing plate and then dried, it is preferred that the dispersion or solution of the matting agent is sprayed onto the surface of the photosensitive layer of the photosensitive lithographic printing plate and then dried thereby to fuse onto the surface. As the spraying method, there can be employed known methods such as air-spraying method, airless-spraying method, electrostatic air-spraying method and electrostatic spray-coating method. Also a uniform dispersion or solution of constituent components of the matting agent used in the production of the matting agent may be directly splayed on the photosensitive layer, and then dried.

The amount of the matting agent applied onto the surface of the photosensitive lithographic printing plate is not specifically limited, but is preferably from 0.001 to 3 g/m², and more preferably from 0.01 to 2 g/m².

<Photosensitive Lithographic Printing Plate>

The photosensitive lithographic printing plate of interest in the present invention is not specifically limited as far as it has sensitivity to infrared radiation, that is, a maximum absorption wavelength is within a range from 760 nm to 1200 nm, and various known photosensitive lithographic printing plates having a photosensitive layer can be employed. Particularly, those of various known thermal positive types, thermal negative types, photopolymer types and process-less types of photosensitive layers, as described hereinafter, are preferable. These preferable photosensitive lithographic printing plates will now be described below.

(Thermal Positive Type)

A photosensitive layer of the thermal positive type contains an alkali soluble polymer compound and a photothermal conversion material. Preferred examples of the alkali soluble polymer compound include homopolymers having an acidic group in the polymers, copolymers thereof, and mixtures thereof. In view of solubility in alkali developing solution, particularly preferred are polymer compounds having an acidic group as described in the following (1) or (2):
(1) phenolic hydroxy group (—Ar—OH, wherein Ar is an arylene group), and
(2) sulfonamide group (—SO₂NH—R, wherein R is a hydrogen atom or an alkyl group).

Above all, it is preferred that the polymer compounds have a phenolic hydroxyl group in view of excellent image forming properties when exposed to infrared laser. Specific examples thereof include novolak resins such as phenol formaldehyde resin, m-cresol formaldehyde resin, p-cresol formaldehyde resin, m-/p-mixed cresol formaldehyde resin, and phenol/(m-, p- or m-/p-mixed) cresol mixed formaldehyde resin; and pyrogallol acetone resin. More specifically, polymers described in paragraphs [0023] to [0042] in Japanese Unexamined Patent Publication (Kokai) No. 2001-305722 and modified phenol resins described in WO02/053627 are preferably used.

The photothermal conversion material makes it possible to convert exposure energy to heat and attain an efficient interaction cancellation in the exposed area of the photosensitive layer. In view of recording sensitivity, a pigment or dye having a light absorption wavelength within an infrared ray range which corresponds to wavelengths of 700 to 1200 nm is preferred. Specific examples of the dye include azo dyes, metal complex salt azo dyes, pyrrozolone azo dyes, naphthoquinone dyes, anthraquinone dyes, phthalocyanine dyes, carbonium dyes, quinoneimine dyes, methine dyes, cyanine dyes, squarylium dyes, pyrylium dyes, and metal thiolate complexes (for example, a nickel thiolate complex). Particularly preferred are cyanine dyes, for example, cyanine dyes represented by the general formula (I) disclosed in Japanese Unexamined Patent Publication (Kokai) No. 2001-305722. It is preferred to add, to the thermal positive working composition, the same sensitivity adjustors, printing-out agents, dyes, surfactants for improving the application performance, and other compounds, similarly to the case of the above-mentioned conventional positive type. Specifically, compounds described in paragraphs [0053] to [0059] in Japanese Unexamined Patent Publication (Kokai) No. 2001-305722 are preferred.

The photosensitive layer of the thermal positive type may have a monolayer structure, or a bilayer structure as described in Japanese Unexamined Patent Publication (Kokai) No. 11-218914.

(Thermal Negative Type)

A photosensitive layer of the thermal negative type is a negative working photosensitive layer, wherein, when exposed with infrared laser, the radiated portions are cured to form image areas. A preferred example of such a thermal negative working photosensitive layer is a polymerizable type layer (hereinafter referred to as a “polymerizable layer”). The polymerizable layer contains (A) an infrared absorber, (B) a radical generator (radical polymerization initiator), (C) a radical polymerizable compound which undergoes polymerization reaction by radicals generated, and thereby be cured, and (D) a binder polymer.

In the polymerizable layer, infrared radiation which the infrared absorber absorbs is converted to heat, and the heat generated at this time causes the radical polymerization initiator such as an onium salt to be decomposed, so as to generate radicals. The radical polymerizable compound is selected from compounds having terminal ethylenically unsaturated bonds, and undergoes a polymerization chain reaction by the generated radicals, so that the compound is cured.

The infrared absorber (A) is, for example, the above-mentioned photothermal conversion material contained in the above-mentioned thermal positive working photosensitive layer. Specific examples of the cyanine dye include dyes described in paragraphs [0017] to [0019] in Japanese Unexamined Patent Publication (Kokai) No. 2001-133969.

The radical generator (B) is, for example, an onium salt. Specific examples of the onium salt which is preferably used include salts described in paragraphs [0030] to [0033] in Japanese Unexamined Patent Publication (Kokai) No. 2001-133969.

The radical polymerizable compound (C) is selected from compounds having one or more, preferably two or more terminal ethylenically unsaturated bonds.

The binder polymer (D) is preferably a linear organic polymer, and is selected from linear organic polymers soluble or swelling in water or alkalescent water. Among these polymers, (meth)acryl resins having a benzyl group or an allyl group, and a carboxyl group on the side chain are preferable because the resin is excellent in balance of film strength, sensitivity and developing property.

As the radical polymerizable compound (C) and the binder polymer (D), materials described in paragraphs [0036] to [0060] in Japanese Unexamined Patent Publication (Kokai) No. 2001-133969 can be used. As other additives, additives (for example, a surfactant for improving coatability) described in paragraphs [0061] to [0068] are preferably used.

A preferred example of the thermal negative working photosensitive layer is an acid crosslinkable type layer (referred to as an “acid crosslinkable layer” hereinafter) besides the polymerizing type layer. The acid crosslinkable layer contains (E) a compound which can generate an acid due to light or heat (referred to as an “acid generator” hereinafter), and (F) a compound which can be crosslinked by the generated acid, (referred to as a “crosslinking agent”), and further contains (G) an alkali soluble polymer compound which can react with the crosslinking agent in the presence of the acid. In order to use the energy of an infrared laser effectively, the infrared absorber (A) is incorporated into the acid crosslinkable layer.

The acid generator (E) may be any compound which can be thermally decomposed to generate an acid (for example, 3-diazo-4-methoxydipheylamine trifluoromethanesulfonate), and examples thereof include a photoinitiator for photopolymerization, a photo alterant for dyes, an acid generator used in micro-resists.

Examples of the crosslinking agent (F) include (i) aromatic compounds substituted with a hydroxymethyl group or an alkoxymethyl group, (ii) compounds having an N-hydroxymethyl, N-alkoxymethyl or N-acyloxymethyl group, and (iii) epoxy compounds.

Examples of the alkali soluble polymer compound (G) include novolak resin, and polymer having a hydroxyaryl group on the side chain.

(Photopolymer Type)

A photopolymer type photosensitive layer is formed of a photopolymerizable photosensitive composition (referred to as a “photopolymerizable composition” hereinafter) and contains an ethylenically unsaturated bond-containing compound which is addition-polymerizable (referred to merely as an “ethylenically unsaturated bond-containing compound” hereinafter), a photopolymerization initiator and a polymer binder as essential components and optionally contains various compounds such as colorant, plasticizer, and thermopolymerization inhibitor.

The ethylenically unsaturated bond-containing compound is a compound having an ethylenically unsaturated bond which is addition-polymerized, crosslinked and cured by an action of the photopolymerization initiator when the photopolymerizable composition is irradiated with actinic ray. The ethylenically unsaturated bond-containing compound can be arbitrarily selected from compounds having at least one terminal ethylenically unsaturated bond, preferably two or more terminal ethylenically unsaturated bonds, and takes the chemical morphology of a monomer, a prepolymer (that is, dimer, trimer, or oligomer), a mixture thereof or a copolymer thereof, or in some other chemical morphology. Examples of the monomer include an ester of an unsaturated carboxylic acid (such as acrylic acid, methacrylic acid, itaconic acid, crotonic acid, isocrotonic acid or maleic acid) with an aliphatic polyhydric alcohol compound, and an amide of an unsaturated carboxylic acid with an aliphatic polyvalent amine compound. Urethane-based addition-polymerizable compounds are also preferred.

The photopolymerization initiator can be appropriately selected from various photopolymerization initiators and combination systems of two or more photopolymerization initiators (photo initiator systems), depending on the wavelength of a light source to be used. For example, initiator systems described in paragraphs [0021] to [0023] in Japanese Unexamined Patent Publication (Kokai) No. 2001-22079 are preferred.

As the polymer binder, alkali water soluble or swelling organic polymers are used because the binder, which functions as an agent for forming the film of the photopolymerizable composition, must cause the dissolution of the photosensitive layer in an alkali developing solution. As the polymers, polymers described in Japanese Unexamined Patent Publication (Kokai) No. 2001-22079 are useful. It is also preferred to add additives (for example, a surfactant for improving coatability) disclosed in paragraphs [0079] to [0088] in the same publication to the photopolymerizable composition.

In order to prevent the polymerization inhibiting action of oxygen, it is also preferred to provide an oxygen-blocking protective layer on or over the photosensitive layer. Examples of the polymer contained in the oxygen-blocking protective layer are polyvinyl alcohol and copolymers thereof.

(Processless Type)

A photosensitive layer of the processless type is classified into a thermoplastic fine particle polymer type, a microcapsule type, and a sulfonic acid-generating polymer containing type. The present invention is particularly suitable for a processless type which is developed on a printing press.

—Thermoplastic Fine Particle Polymer Type—

In the thermoplastic fine particle polymer type, hydrophobic heat-meltable resin fine particles (H) are dispersed in a hydrophilic polymer matrix (J). At exposure, the hydrophobic polymer is melted by heat generated in exposed areas, so that the melted polymer is fused to each other. As a result, hydrophobic portions made of the polymer, namely, image areas are formed. The hydrophobic heat-meltable resin fine particles (H) (referred to as “polymer fine particles” hereinafter) are preferably fused and combined with each other by heat, and the particles (H) are more preferably particles which have hydrophilic surfaces and can be dispersed in a hydrophilic component such as dampening water.

Preferred examples of the polymer fine particles include thermoplastic polymer fine particles described in Research Disclosure No. 33303 (January in 1992), Japanese Unexamined Patent Publication (Kokai) Nos. 9-123387, 9-131850, 9-171249 and 9-171250, EP No. 931,647, etc. Specific examples thereof include homopolymers and copolymers of monomers such as ethylene, styrene, vinyl chloride, methyl acrylate, ethyl acrylate, methyl methacrylate, ethyl methacrylate, vinylidene chloride, acrylonitrile, and vinyl carbazole; and mixtures thereof. Particularly preferred are polystyrene and polymethyl methacrylate.

The polymer fine particles having hydrophilic surfaces include substances in which polymers are themselves hydrophilic, such as substances in which polymers constituting fine particles are themselves hydrophilic, or substances to which hydrophilicity is imparted by introducing hydrophilic groups, for example, anionzed groups such as a carboxylic anion, a sulfonic acid anion, a sulfuric acid anion and a phosphonic acid anion into the main chains or side chains of polymers; and substances whose surfaces are made hydrophilic by allowing a hydrophilic polymer, a hydrophilic oligomer or a hydrophilic low molecular weight compound, such as polyvinyl alcohol or polyethylene glycol, to be adsorbed on the surfaces of polymer fine particles. As the polymer fine particles, polymer fine particles having reactive functional groups are more preferred. By dispersing polymer fine particles as described above into the hydrophilic polymer matrix (J), the on-press developing properties are made better in the case of on-press development and, further, the film strength of the photosensitive layer itself is also improved.

—Microcapsule Type—

Preferred examples of the microcapsule type include a type described in Japanese Unexamined Patent Publication (Kokai) No. 2000-118160; and a microcapsule type in which a compound having a thermally reactive functional group is encapsulated as described in Japanese Unexamined Patent Publication (Kokai) No. 2001-277740.

—Sulfonic Acid-Generating Polymer-Containing Type—

Examples of the sulfonic acid-generating polymer include polymers having, on the side chains thereof, sulfonic acid ester groups, disulfonic groups or sec- or tert-sulfonamide groups, described in Japanese Unexamined Patent Publication (Kokai) No. 10-282672.

By incorporating a hydrophilic resin into the processless type photosensitive layer, the on-press developing properties are improved and further the film strength of the photosensitive layer itself is also improved. Moreover, the hydrophilic resin can be crosslinked and cured so that a lithographic printing plate precursor for which no development treatment is required is obtained.

Preferred examples of the hydrophilic resin include resin having a hydrophilic group such as a hydroxyl, carboxyl, hydroxylethyl, hydroxylpropyl, amino, aminoethyl, aminopropyl, or carboxylmethyl group; and hydrophilic sol-gel convertible binder resin. Specific examples of the hydrophilic resin are the same as described as examples of the hydrophilic resin used as the hydrophilic polymer matrix (J) which is used in the photo polymer type photosensitive layer. In the process-less type photosensitive layer, it is preferred to use the sol-gel convertible binder resin among the hydrophilic resins.

It is necessary to add a photothermal conversion material to the process-less type photosensitive layer. The photothermal conversion material may be any material which can absorb light having a wavelength of 700 nm or more. Particularly preferred are the same dyes, which can absorb infrared radiation, as are used in the above-mentioned thermal positive type.

The photosensitive layer of the photosensitive lithographic printing plate according to the present invention can be formed by applying, onto a substrate or a subbing layer formed optionally on the substrate, a solution containing components of the photosensitive layer.

Examples of the solvent used herein include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetoamide, N,N-dimethylformamide, tetramethylurea, N-methyl pyrrolidone, dimethyl sulfoxide, sulfolane, γ-butyrolatone, and toluene. When using a water soluble photosensitive layer, examples of the solvent are aqueous solvents such as water and alcohols. However, the solvent is not limited to these examples, and the solvent may be appropriately selected in accordance with physical properties of the image forming layer. These solvents are used alone or in the form of a mixture thereof. The concentration of the above-mentioned respective components (all solid contents including the additives) in the solvent is preferably from 1 to 50% by mass.

The coating weight (of all the solid contents) on the substrate after the solution is applied and dried varies depending on the use. In the case of a lithographic printing plate precursor, in general, the coating weight is preferably from 0.5 to 5.0 g/m². As the coating weight is lower, the apparent sensitivity increases, however the film property of the recording layer degrade. The photosensitive composition applied on the substrate is usually dried at ambient temperature. In order to dry within a short time, the photosensitive composition may be dried at 30 to 150° C. for 10 seconds to 10 minutes using a hot-air dryer or an infrared dryer.

The method of the application may be any one selected from various methods, including roll coating, dip coating, air knife coating, gravure coating gravure offset coating, hopper coating, blade coating, wire doctor coating, and spray coating.

<Other Layers>

The photosensitive lithographic printing plate of the present invention may appropriately include not only the photosensitive layer but also other layers such as a subbing layer, an overcoat layer and a back coat layer in accordance with a desired property. Preferred examples of the back coat layer include coat layers made of an organic polymer compound described in Japanese Unexamined Patent Publication (Kokai) No. 5-45885 and coat layers made of a metal oxide obtained by hydrolyzing and polycondensating an organic or inorganic metal compound, described in Japanese Unexamined Patent Publication (Kokai) No. 6-35174. Among these coat layers, particularly preferred is the coat layer made of the metal oxide obtained from an alkoxyl compound of silicon, such as Si(OCH₃)₄Si(OC₂H₅)₄, Si(OC₃H₇)₄ or Si(OC₄H₉)₄, which is inexpensive and easily available, as the coat layer is excellent in development resistance.

<Substrate>

The substrate used in the present invention can be arbitrarily selected from materials having required properties such as strength, durability and flexibility.

Examples of the substrate used include metal plates such as aluminum, zinc, copper, stainless steel, and iron plates; plastic films such as polyethylene terephthalate, polycarbonate, polyvinyl acetal, and polyethylene films; composite materials such as composite material obtained by vacuum-depositing or laminating a metal layer on plastic films, and papers on which a synthetic resin is melt-coated or a synthetic resin solution is coated; and other materials used as the substrate of the printing plate. Among these substrates, aluminum and composite substrates coated with aluminum are preferably used.

The surface of the aluminum substrate is preferably subjected to a surface treatment for the purpose of enhancing water retentivity and improving adhesion with the photosensitive layer. Examples of the surface treatment include surface roughening treatments such as brush graining, ball graining, electrolytic etching, chemical etching, liquid honing, sand blasting, and a combination thereof. Among these surface treatments, a surface roughening treatment including the use of electrolytic etching is preferable.

As the electrolytic bath used in the electrolytic etching, an aqueous solution containing acid, alkali or a salt thereof, or an aqueous solution containing an organic solvent is used. Among these, an electrolytic solution containing hydrochloric acid, nitric acid, or a salt thereof is preferable.

The aluminum substrate subjected to the surface roughening treatment is further subjected to desmutting using an aqueous solution of an acid or alkali, if necessary. The aluminum substrate thus obtained is preferably subjected to an anodizing treatment. In particular, an anodizing treatment in a bath containing sulfuric acid or phosphoric acid is preferable.

The aluminum substrate is preferably subjected to a hydrophilization treatment after subjecting to the surface roughening treatment (graining treatment) and the anodizing treatment. The hydrophilization treatment can be conducted by dipping of an aluminum substrate in hot water or a hot water solution containing an inorganic or organic salt, sealing treatment with steam bath, silicate treatment (sodium silicate, potassium silicate), potassium fluorozirconate treatment, phosphomolybdate treatment, alkyl titanate treatment, polyacrylic acid treatment, polyvinylsulfonic acid treatment, polyvinylphosphonic acid treatment, phytic acid treatment, treatment with a salt of hydrophilic organic polymer compound and divalent metal, hydrophilization treatment by undercoating with a water soluble polymer having an sulfonic acid group, coloring treatment with an acidic dye, and electrolitic deposition with silicate.

The photosensitive lithographic printing plate of the present invention can be prepared as described above.

<Exposure and Development>

The photosensitive lithographic printing plate treated with the matting agent of the present invention is imagewise exposed to light in accordance with properties of respective photosensitive layers thereof. Specific examples of the method of the exposure include light irradiation using such as infrared laser, an ultraviolet lamp, and visible ray; electron beam irradiation such as γ-ray radiation; and thermal energy application employing such as a thermal head, a heat roll, a heating zone using a non-contact type heater or hot wind. The photosensitive lithographic printing plate of the present invention can be used as so-called computer-to-plate (CTP) plate capable of directly writing images on a plate using laser based on digital image information from a computer. It is also possible to write images by a method using techniques such as a GLV (Grafting Light Valve) and a DMD (Digital Mirror Device) as digital image writing means.

As a light source of laser for exposure of the lithographic printing plate precursor of the present invention, high-output laser having a maximum intensity within a near infrared to infrared range is used most preferably. Examples of the high-output laser having a maximum intensity within a near infrared to infrared range include various lasers having a maximum intensity within a near infrared to infrared range of 760 to 3000 nm, for example, semiconductor or YAG laser having a maximum intensity within a near infrared to infrared range of 760 to 1200 nm. If necessary, development treatment may be conducted after writing images on the photosensitive layer using laser and heat-treating in a heat oven.

The photosensitive lithographic printing plate of the present invention is converted into a lithographic printing plate having the image area formed thereon by writing images on the photosensitive layer using laser, followed by developing and removing the non-image area with a wet method. Water or an aqueous developing solution can be used as the developing solution for developing.

An aqueous alkali solution having the pH of 12 or higher is usually used as the aqueous developing solution.

Examples of the alkali agent used in the developing solution include inorganic alkali compounds such as sodium silicate, potassium silicate, potassium hydroxide, sodium hydroxide, lithium hydroxide, sodium, potassium or ammonium salts of secondary or tertiary phosphoric acid, sodium metasilicate, sodium carbonate, and ammonia; and organic alkali compounds such as monomethylamine, dimethylamine, trimethylamide, monoethylamine, diethylamine, triethylamine, monoisopropylamine, diisopropylamine, triisopropylamine, n-butylamine, di-n-butylamine, monoethanolamine, diethanolamine, triethanolamine, ethyleneimine, and ethylenediamine.

The content of the alkali agent in the developing solution is preferably within a range from 0.005 to 10% by mass, and particularly preferably from 0.05 to 5% by mass. The content of the alkali agent in the developing solution of less than 0.005% by mass is not preferable because the development may not be conducted sufficiently. The content of more than 10% by mass is not preferable because an adverse influence such as corrosion of the image area is exerted on development.

An organic solvent can also be added to the developing solution. Examples of the organic solvent, which can be added to the developing solution, include ethyl acetate, butyl acetate, amyl acetate, benzyl acetate, ethylene glycol monobutyl acetate, butyl lactate, butyl levulinate, methyl ethyl ketone, ethyl butyl ketone, methyl isobutyl ketone, cyclohexanone, ethylene glycol monobutyl ether, ethylene glycol monobenzyl ether, ethylene glycol monophenyl ether, benzyl alcohol, methylphenyl carbitol, n-amyl alcohol, methylamyl alcohol, xylene, methylene dichloride, ethylene dichloride, and monochlorobenzene. When the organic solvent is added to the developing solution, the content of the organic solvent is preferably 20% by mass or less, and particularly preferably 10% by mass or less.

If necessary, it is also possible to add, to the developing solution, water soluble sulfites such as lithium sulfite, sodium sulfite, potassium sulfite, and magnesium sulfite; hydroxyaromatic compounds such as alkali soluble pyrazolone compound, alkali soluble thiol compound, and methyl resorcin; water softeners such as polyphosphate and aminopolycarboxylic acids; various surfactants, for example, anionic surfactants such as sodium isopropylnaphthalenesulfonate, sodium n-butylnaphthalenesulfonate, sodium N-methyl-N-pentadecylaminoacetate, and sodium lauryl sulfate, cationic surfactants, amphoteric surfactants and fluorine-based surfactants; and various defoamers. Furthermore, the developing solution may contain colorants, plasticizers, cheleting agents, and stabilizers.

As the developing solution, commercially available developing solutions for a negative- or a positive-working PS plate can be used. Specifically, a solution prepared by diluting a commercially available concentrated developing solution for a negative- or a positive-working PS plate 1 to 1000 times can be used as the developing solution in the present invention.

The process-less type photosensitive lithographic printing plate of the present invention can be developed with water according to characteristics of the photosensitive layer. Therefore, after writing images on the photosensitive layer using laser and mounting the plate to a printing press without being subjecting to a conventional development treatment with a strong alkali developing solution, dampening water is fed to the plate on the printing press, thus the plate can be developed with the dampening water.

The temperature of the developing solution is preferably within a range from 5 to 90° C., and particularly preferably from 10 to 50° C. The dipping time is preferably within a range from 1 second to 5 minutes. If necessary, the surface can be slightly rubbed during the development.

After the completion of the development, the lithographic printing plate is washed with water and/or subjected to a treatment with an aqueous desensitizing agent. Examples of the aqueous desensitizing agent include aqueous solutions of water soluble natural polymers such as gum arabic, dextrin, and carboxymethyl cellulose, and aqueous solutions of water soluble synthetic polymers such as polyvinyl alcohol, polyvinyl pyrrolidone, and polyacrylic acid. If necessary, acids or surfactants are added to these aqueous desensitizing agents. After subjecting to a treatment with the desensitizing agent, the lithographic printing plate is dried and then used for printing as a press plate.

Durable images can be obtained by subjecting to a heat treatment after the development. The heat treatment is preferably conducted at a temperature within a range from 70 to 300° C. Preferable heating time varies depending on the heating temperature and is from about 10 seconds to 30 minutes.

The photosensitive lithographic printing plate treated with the matting agent of the present invention is capable of recording images by scanning exposure based on digital signals, and the recorded images can be developed with water or an aqueous developing solution. Alternatively, printing can be conducted by mounting the printing plate to a printing press without developing.

### EXAMPLES

The present invention will now be described in detail below by referring examples, but the present invention is not limited to the scope of the following examples.

### Example 1

A thermal positive working CTP plate treated with a matting agent was produced in the following manner.

On an electrically roughened aluminum support, a coating solution with the formula shown in Table 1 was applied using a rod bar #12, followed by drying at 100° C. for 2 minutes. A dry coating weight was 2.0 g/m².

TABLE 1

| Components | Weight | |
|---|---|---|
| m,p-cresolnovolak resin | 9.3 | g |
| Crystal Violet | 0.2 | g |
| Cyanine dye A | 0.1 | g |
| Cyanine dye B | 0.1 | g |
| Pyrromellitic anhydride | 0.3 | g |
| 1-methoxy-2-propanol | 70.0 | g |
| Methanol | 20.0 | g |

*Cyanine dye A

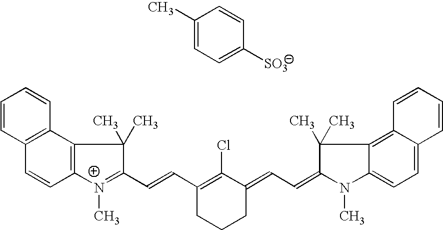

*Cyanine dye B

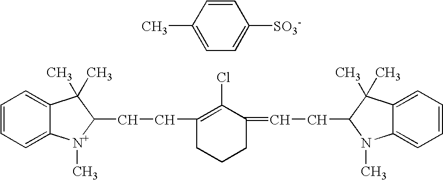

On the surface of the photosensitive lithographic printing plate produced as described above, each of solutions A and B with two kinds of formulae shown in Table 2 was sprayed using a glass spraying apparatus and then dried. A particle size of a matting agent applied on the surface of the photosensitive lithographic printing plate was 100 μm on average.

TABLE 2

| | | Solution B |
|---|---|---|
| Components | Solution A | (Comparison) |
| m,p-cresol novolak resin | 9.3 g | 9.3 g |
| Crystal Violet | 0.2 g | 0.2 g |
| Cyanine dye A | 0.1 g | — |
| Cyanine dye B | 0.1 g | — |
| Pyromellitic anhydride | 0.3 g | 0.3 g |
| 1-methoxy-2-propanol | 70.0 g | 70.0 g |
| Methanol | 20.0 g | 20.0 g |

Each of photosensitive lithographic printing plates A and B surface-treated with solutions A and B, and a non-surface-treated photosensitive lithographic printing plate C was exposed to light at 100%, 50% and 0% dots using Trendsetter 3244 (9 w/150 rpm: manufactured by Creo Corp.) and then developed with a developing solution prepared by diluting a stock developing solution PD1 (manufactured by Kodak Polychrome Graphics Japan) by 8 times with water at 30° C. for 25 seconds using a processor PK910 (manufactured by Kodak Polychrome Graphics Japan).

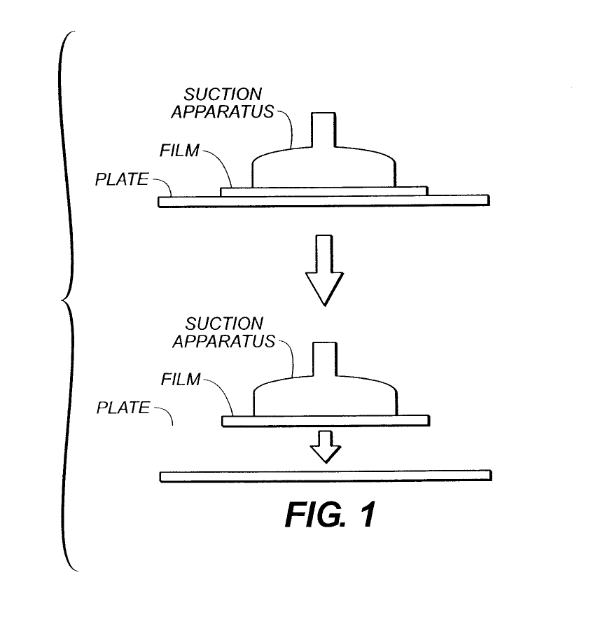

As shown in FIG. 1, in case of sucking from the film side in the state where a film is placed on the surface of a photosensitive lithographic printing plate, using a suction apparatus, the suction/falling characteristics of photosensitive lithographic printing plates A, B and C were evaluated by measuring the time in which the photosensitive lithographic printing plate together with the film are retained by the suction apparatus. The results are shown in Table 3.

TABLE 3

| | | | | Suction |
|---|---|---|---|---|
| | Measurement of sensitivity | | | retention |
| | 100% dots | 50% dots | 0% dots | time |
| Photosensitive | excellent | excellent | excellent | 10 seconds |
| lithographic | | | | |
| printing plate A | | | | |
| Photosensitive | excellent | Spots | Spots | 10 seconds |
| lithographic | | appeared | appeared | |
| printing plate B | | | | |
| Photosensitive | excellent | excellent | excellent | 41 seconds |
| lithographic | | | | |
| printing plate C | | | | |

The photosensitive lithographic printing plate A of the present invention has excellent sensitivity and suction/falling characteristics. To the contrary, the photosensitive lithographic printing plate B has excellent suction/falling characteristics, but is not suited for practical use because spots (0% dots and 50% dots) appeared in the non-image area. The photosensitive lithographic printing plate C has excellent sensitivity, but is inferior in suction/falling characteristics and may causes blocking with a interleaving paper.

### Example 2

A preheated thermal negative working CTP plate treated with a matting agent was produced in the following manner.

On an electrolytically grained, anodized and hydrophilized aluminum support, a coating solution with the formula shown in Table 4 was applied using a rod bar #8, followed by drying at 100° C. for 2 minutes. A dry coating weight was 1.5 g/m².

TABLE 4

| | Coating | |
|---|---|---|
| Components | solution | |
| Methyl cellosolve | 450.0 | g |
| Methyl ethyl ketone | 450.0 | g |
| Resol resin | 35.0 | g |
| m-cresol novolak resin | 50.0 | g |
| 3-diazo-4-methoxydiphenylamine | 6.0 | g |
| trifluoromethanesulfonate | | |
| Cyanine dye A | 6.0 | g |
| Cyanine dye B | 2.0 | g |
| D11 (manufactured by PCAS Co.) | 1.0 | g |
| DC190 (10% solution) | 6.0 | g |

*D-11

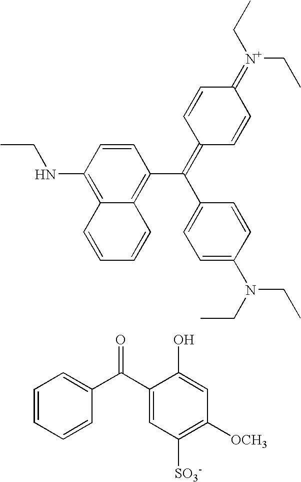

On the surface of the photosensitive lithographic printing plate produced as described above, each of solutions D and E with two kinds of formulae shown in Table 5 was sprayed using a glass spraying apparatus and then dried. A particle size of a matting agent applied on the surface of the photosensitive lithographic printing plate was 100 μm on average.

TABLE 5

| | | Solution E |
|---|---|---|
| Components | Solution D | (comparison) |
| Methyl cellosolve | 450.0 g | 450.0 g |
| Methyl ethyl ketone | 450.0 g | 450.0 g |
| Resol resin | 35.0 g | 35.0 g |
| m-cresol novolak resin | 50.0 | 50.0 g |
| 3-diazo-4-methoxydiphenylamine | 6.0 g | 6.0 g |
| trifluoromethansulfonate | | |
| Cyanine dye A | 6.0 g | — |
| Cyanine dye B | 2.0 g | — |
| D11 (manufactured by PCAS Co.) | 1.0 g | 1.0 g |
| DC190 (10% solution) | 6.0 g | 6.0 g |

Each of photosensitive lithographic printing plates D and E surface-treated with solutions D and E, and a non-surface-treated photosensitive lithographic printing plate F was exposed to light at 100%, 50% and 0% dots using Trendsetter 3244 (8 w/150 rpm: manufactured by Creo Corp.), preheated at a rate of 2.5 feet/min (0.76 m/second) at 275 deg-F using a Wisconsin oven, and then developed with a developing solution prepared by diluting a stock developing solution PD1R (manufactured by Kodak Polychrome Graphics Japan) 5 times with water at 30° C. for 25 seconds using a processor PK910 (manufactured by Kodak Polychrome Graphics Japan).

In the same manner as in Example 1, suction/falling characteristics of photosensitive lithographic printing plates D, E and F were evaluated.

The results are shown in Table 6.

TABLE 6

| | | | | Suction |
|---|---|---|---|---|
| | Measurement of sensitivity | | | retention |
| | 100% dots | 50% dots | 0% dots | time |
| Photosensitive | excellent | excellent | excellent | 9 seconds |
| lithographic | | | | |
| printing plate D | | | | |
| Photosensitive | Voids | Chipping | excellent | 10 seconds |
| lithographic | appeared | appeared | | |
| printing plate E | | | | |
| Photosensitive | excellent | excellent | excellent | 37 seconds |
| lithographic | | | | |
| printing plate F | | | | |

The photosensitive lithographic printing plate of the present invention D has excellent sensitivity and suction/falling characteristics. To the contrary, the photosensitive lithographic printing plate E has good suction/falling characteristics, but is not suited for practical use because voids (100% dots) and missing of dots (50% dots) appeared in the image area. The photosensitive lithographic printing plate F has excellent sensitivity, but is inferior in suction/falling characteristics and may causes blocking with a laminated-paper.

### Example 3

An infrared laser photo-mode negative working CTP plate treated with a matting agent was produced in the following manner.

On an electrolytic grained, anodized and hydrophilized aluminum substrate, a coating solution with the formula shown in Table 7 was applied using a rod bar #12, followed by drying at 110° C. for 30 seconds. A dry coating weight was 2.0 g/m².

TABLE 7

| | Coating | |
|---|---|---|
| Components | solution | |
| Binder resin | 4.8 | g |
| Onium salt | 0.9 | g |
| Dipentaerythritol hexaacrylate | 3.0 | g |
| Organic boron initiator | 0.6 | g |
| Infrared absorber | 0.2 | g |
| DC190 (30% MEK) | 0.2 | g |
| Crystal Violet | 0.3 | g |
| Methyl cellosolve | 70.0 | g |
| Methyl ethyl ketone | 20.0 | g |

*Binder resin

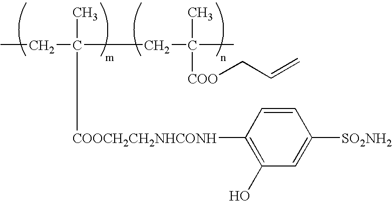

*Onium salt

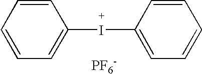

*Organic boron initiator

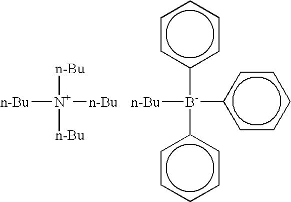

*Infrared absorber

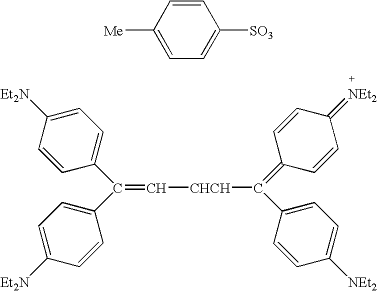

On the surface of the photosensitive lithographic printing plate produced as described above, each of solutions G and H with two kinds of formulae shown in Table 8 was sprayed using a glass spraying apparatus and then dried. A particle size of a matting agent applied on the surface of the photosensitive lithographic printing plate was 100 μm on average.

TABLE 8

| | | Solution H |
|---|---|---|
| Components | Solution G | (comparison) |
| Watersol ACD-1123 | 227.0 g | 227.0 g |
| Isopropyl alcohol | 250.0 g | 250.0 g |
| Deionized water | 523.0 g | 523.0 g |
| Metanyl Yellow | 0.2 g | 0.2 g |
| IR dye S0306 | 0.5 g | — |
| Defoamer | 0.1 g | 0.1 g |

*Watersol ACD-1123: N,N-dimethylacrylamide/EMA/MAAm =
60/20/20 (weight ratio)
*Metanyl Yellow: Color Index No. 13065
(CAS. No. [587-98-4]
*IR dye S0306

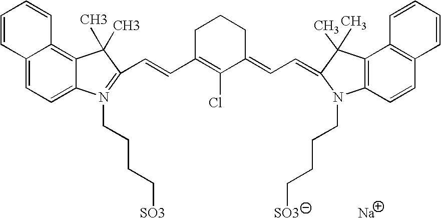

*Defoamer: aqueous emulsion of 16% dimethylpolysiloxane
(manufactured by Nikko Chemicals Co., Ltd.)

Each of the photosensitive lithographic printing plates D and E surface-treated with solutions G and H, and a non-surface-treated photosensitive lithographic printing plate I was exposed to light at 100%, 50% and 0% dots using Trendsetter 3244 (10 w/150 rpm: manufactured by Creo Corp.) and then developed with a developing solution prepared by mixing a stock developing solution PD1, NBL and water in a mixing ratio 14/40/140 at 30° C. for 10, 15 or 20 seconds using a processor PK910 (manufactured by Kodak Polychrome Graphics Japan).

In the same manner as in Example 1, suction/falling characteristics of photosensitive lithographic printing plates G, H and I were evaluated.

TABLE 9

| | Measurement of sensitivity | | | | | | | | | |
|---|---|---|---|---|---|---|---|---|---|---|
| | 100% dots | | | 50% dots | | | 0% dots | | | Suction |
| | 10 s | 15 s | 20 s | 10 s | 15 s | 20 s | 10 s | 15 s | 20 s | retention time |
| Photosensitive | ex | ex | ex | ex | ex | ex | ex | ex | ex | 9 seconds |
| lithographic | | | | | | | | | | |
| printing plate G | | | | | | | | | | |
| Photosensitive | ex | ex | ex | Spots | ac | ex | Spots | ac | ex | 10 seconds |
| lithographic | | | | appeared | | | appeared | | | |
| printing plate H | | | | | | | | | | |
| Photosensitive | ex | ex | ex | ex | ex | ex | ex | ex | ex | 37 seconds |
| lithographic | | | | | | | | | | |
| printing plate I | | | | | | | | | | |

(Note)
ex: excellent
ac: acceptable

The photosensitive lithographic printing plate G of the present invention has excellent sensitivity and suction/falling characteristics. On the contrary, in the photosensitive lithographic printing plate H, spots (50% and 100% dots) appeared in the non-image area when developed for 10 seconds, while an acceptable grade can be attained when developed for 15 seconds. Therefore, development latitude of the photosensitive lithographic printing plate H is narrower than that of the photosensitive lithographic printing plate G. The photosensitive lithographic printing plate F has excellent sensitivity, but is inferior in suction/falling characteristics and may causes blocking with a interleaving paper.

### Example 4

A thermal negative working CTP plate treated with a matting agent was produced in the following manner.

On an electrolytic grained, anodized and hydrophilized aluminum support, a coating solution with the formula shown in Table 10 was applied using a rod bar #12, followed by drying at 80° C. for 60 seconds. The dry coating weight was 2.0 g/m².

TABLE 10

| Components | Coating solution |
|---|---|
| Water-dispersible resin | 1.0 g |
| Aqueous 18% ammonia solution | 0.5 g |
| Ethanol | 2.5 g |
| Cyanine dye A | 0.1 g |
| Crystal Violet | 0.01 g |
| DC190 (10% solution) | 0.2 g |
| Deionized water | 9.0 g |

*Water-dispersible resin
Maleic anhydrdie/styrene/acrylonitrile = 15/55/30 (weight ratio) copolymer

On the surface of the photosensitive lithographic printing plate produced as described above, each of solutions J and K with two kinds of formulae shown in Table 11 was sprayed using a glass spraying apparatus and then dried. A particle size of a matting agent applied on the surface of the photosensitive lithographic printing plate was 100 μm on average.

TABLE 11

| | | Solution K |
|---|---|---|
| Components | Solution J | (comparison) |
| Watersol ACD-1123 | 200.0 g | 200.0 g |
| Isopropyl alcohol | 275.0 g | 275.0 g |
| Deionized water | 525.0 g | 525.0 g |
| Metanyl Yellow | 0.2 g | 0.2 g |
| Cyanine dye A | 0.05 g | — |
| Defoamer | 0.1 g | 0.1 g |

Each of photosensitive lithographic printing plates J and K surface-treated with solutions J and K, and a non-surface-treated photosensitive lithographic printing plate L was exposed to light at 100%, 50% and 0% dots using Trendsetter 3244 (10 w/150 rpm: manufactured by Creo Corp.) and then developed with a developing solution F18 at 30° C. for 15, 20 or 25 seconds using a processor PK910 (manufactured by Kodak Polychrome Graphics Japan).

In the same manner as in Example 1, suction/falling characteristics of photosensitive lithographic printing plates J, K and L were evaluated.

The results are shown in Table 12.

TABLE 12

| | Measurement of sensitivity | | | | | | | | | |
|---|---|---|---|---|---|---|---|---|---|---|
| | 100% dots | | | 50% dots | | | 0% dots | | | Suction |
| | 15 s | 20 s | 25 s | 15 s | 20 s | 25 s | 15 s | 20 s | 25 s | retention time |
| Photosensitive | ex | ex | ex | ex | ex | ex | ex | ex | ex | 10 seconds |
| lithographic | | | | | | | | | | |
| printing plate J | | | | | | | | | | |
| Photosensitive | ex | ex | Voids | Spots | ex | Voids | spots | ex | ex | 11 seconds |
| lithographic | | | | | | | | | | |
| printing plate K | | | | | | | | | | |
| Photosensitive | ex | ex | ex | Ex | Ex | ex | ex | ex | ex | 44 seconds |
| lithographic | | | | | | | | | | |
| printing plate L | | | | | | | | | | |

(Note)
ex: excellent

The photosensitive lithographic printing plate J of the present invention has excellent sensitivity and suction/falling characteristics. To the contrary, in the photosensitive lithographic printing plate K, spots (50% and 0% dots) appeared in the non-image area when developed for 15 seconds, while voids appeared when developed for 25 seconds. Therefore, development latitude of the photosensitive lithographic printing plate K is narrower than that of the photosensitive lithographic printing plate J. The photosensitive lithographic printing plate L has excellent sensitivity, but is inferior in suction/falling characteristics and may causes blocking with a interleaving paper.

### Example 5

The following three kinds of photosensitive lithographic printing plates were produced.

### (1) Comparative Example L

This example is the same as the printing plate L produced in Example 4

### (2) Comparative Example M

This example is the same as the printing plate L produced in Example 4, except that 0.5% by weight of polymer beads (polyester beads: average particle size: 6 μm, manufactured by Paul West Co.) was added to the coating solution. A dry coating weight was 2.0 g/m².

### (3) Photosensitive Lithographic Printing Plate N

The photosensitive lithographic printing plate was obtained by spraying a solution J on the photosensitive lithographic printing plate L using an electrostatic spraying gun. The spraying gun was used under the following conditions.

TABLE 13

| | | |
|---|---|---|
| Cup size | 50 | mm in diameter |
| Rotating number | 12000 | rpm |
| Supply amount | 36 | ml/min |
| Average particle size of | 15 | μm |
| matting particles | | |

Printing plates L, M and N were subjected to a test on suction retention characteristics and a test on workability using a domestically-made automatic pickup apparatus equipped with a vacuum suction system. The results are shown in Table 14.

TABLE 14

| | Treatment with | Suction | |
|---|---|---|---|
| | matting agent | retention | Workability |
| Photosensitive | Spray gun | 10 | A |
| lithographic | | seconds | |
| printing plate N | | | |
| Comparative | Polymer beads | 19 | C |
| Example M | containing | seconds | |
| | photosensitive | | |
| | layer | | |
| Comparative | None | 43 | D |
| Example L | | seconds | |

(Note)
A: pickup could be conducted without causing any problem
C: pickup could be conducted at normal or low speed without causing any problem
D: unacceptable

In Comparative Example L, operations such as pickup, suction and retention could be conducted without causing any problem when a interleaving paper is used. When the interleaving paper is not used, operations such as pickup, suction and retention could be conducted without even when no interleaving paper is used. In case of Comparative Example M and the photosensitive lithographic printing plate N, operations such as pickup, suction and retention could be conducted even when no interleaving paper is used. In view of overall workability, the photosensitive lithographic printing plate N of the present invention was excellent in comparison with Comparative Example M.

1.-6. (canceled)

7. A granular matting agent for application to a photosensitive lithographic printing plate, said matting agent comprising an infrared absorbing dye.

8. The matting agent of claim 7 wherein said matting agent contains an alkali-soluble resin or a water-dispersible resin.

9. The matting agent of claim 7 wherein said infrared absorbing dye is present in an amount of from 0.001 to 30% by mass.

10. The matting agent of claim 7 wherein said infrared absorbing dye is present in an amount of from 0.01 to 10% by mass.

11. The matting agent of claim 7 further comprising a cyclic anhydride, colorant, surfactant, defoamer, or acid generator.

12. The matting agent of claim 7 that is soluble in an alkali developer solution or dispersible in water.

13. An infrared-sensitive lithographic printing plate comprising on the surface thereof, a granular matting agent containing an infrared absorbing dye.

14. The infrared-sensitive lithographic printing plate of claim 13 wherein said matting agent contains an alkali-soluble resin or a water-dispersible resin.

15. The infrared-sensitive lithographic printing plate of claim 13 wherein said infrared absorbing dye is present in said matting agent an amount of from 0.001 to 30% by mass.

16. The infrared-sensitive lithographic printing plate of claim 13 wherein said infrared absorbing dye is present in said matting agent an amount of from 0.01 to 10% by mass.

17. The infrared-sensitive lithographic printing plate of claim 13 wherein said matting agent further comprises a cyclic anhydride, colorant, surfactant, defoamer, or acid generator.

18. The infrared-sensitive lithographic printing plate of claim 13 wherein said matting agent is present in an amount of from 0.001 to 3 g/m².

19. The infrared-sensitive lithographic printing plate of claim 13 wherein said matting agent is present in an amount of from 0.01 to 2 g/m².

20. A method for a surface treatment of a photosensitive lithographic printing plate, wherein the method comprises applying a granular matting agent containing an infrared absorbing dye to the surface of an infrared-sensitive lithographic printing plate.

21. The method of claim 20 wherein said matting agent contains an alkali-soluble resin or a water-dispersible resin.

22. The method of claim 20 wherein said matting agent is applied to provide a coating of from 0.001 to 3 g/m².
